(19) United States
(12) Patent Application Publication
(10) Pub. No.: US 2011/0169813 A1
(43) Pub. Date: Jul. 14, 2011

(54) DISPLAY PANEL DRIVING CIRCUIT HAVING CHARGE SHARING SWITCH FORMED IN PAD

(75) Inventors: Byung-Yun Jin, Cheongju-si (KR); Jong-Geun Park, Cheongju-si (KR); Hyun-Ho Cho, Incheon-si (KR); Joung-Cheul Choi, Daegu-si (KR); Joon-Ho Na, Daejeon-si (KR)

(73) Assignee: SILICON WORKS CO., LTD, Daejeon-si (KR)

(21) Appl. No.: 12/985,667

(22) Filed: Jan. 6, 2011

(30) Foreign Application Priority Data
Jan. 8, 2010 (KR) 10-2010-0001610

(51) Int. Cl. G09G 5/00

(52) U.S. Cl. 345/212

(57) ABSTRACT

A display panel driving circuit includes N number of amplifiers configured to supply N number of output voltages to a display panel; N number of output switches configured to transmit output signals from the N number of amplifiers through N number of pads to the display panel; and a plurality of charge sharing switches configured to share charges among the N number of pads, wherein the charge sharing switches are formed in the pads.

### BACKGROUND OF THE INVENTION

1. Field of the Invention

The present invention relates to a display panel driving circuit, and more particularly, to a display panel driving circuit having charge sharing switches formed in pads, wherein charge sharing switches are formed in pads to serve as ESD (electrostatic discharge) protection devices and decrease an area and a heat value.

2. Description of the Related Art

In general, a semiconductor device is provided with pads for electrically connecting the semiconductor device with an outside. Signals associated with command input and data input/output operations are inputted to or outputted from the semiconductor device through the pads.

Recently, as a design rule of a semiconductor device shrinks, a semiconductor manufacturing technology has been developed to accommodate a trend toward high integration. The size of a semiconductor device is scaled down due to the high integration, and the number of net dies manufactured per a semiconductor wafer is increased, whereby the manufacturing costs can be saved.

Therefore, measures for reducing an entire area of a semiconductor device are required.

FIG. 1 is a diagram illustrating a conventional display panel driving circuit.

Referring to FIG. 1, a conventional display panel driving circuit includes N number of amplifiers 111, 112 and 113, N number of output switches 121, 122 and 123, a plurality of charge sharing switches 131, 132 and 133, and N number of pads 141, 142 and 143. The N number of amplifiers 111, 112 and 113 are configured to buffer or amplify corresponding data DATA1, DATA2 and DATA N. The N number of output switches 121, 122 and 123 are respectively configured to receive the outputs of the N number of amplifiers 111, 112 and 113 and allow or interrupt the transmission of the outputs to the N number of pads 141, 142 and 143. The plurality of charge sharing switches 131, 132 and 133 are configured to share charges between adjacent pads according to control signals CTRL and CTRLb.

Due to the fact that charge sharing between the pads 141, 142 and 143 is enabled by the charge sharing switches 131, 132 and 133, a positive data voltage and a negative data voltage can be shared (that is, the charges charged in a display panel are recycled to be reused), whereby power consumption of the display panel driving circuit can be reduced. However, since the charge sharing switches 131, 132 and 133 occupy a substantial portion of a chip area, limitations exist in decreasing the chip area. Therefore, measures for decreasing the area of the display panel driving circuit in order to decrease the chip area are required.

FIG. 2 is a diagram illustrating circuits on a line through which data is outputted to the first pad by driving one data voltage in the display panel driving circuit shown in FIG. 1 and equivalent circuits in the first pad.

In the first pad 141, a resistor 141-3 is formed between the first charge sharing switch 131 and the first pad 141, a P-type diode 141-1 is formed between a power supply source VDD and a first output terminal PAD OUT1, and an N-type diode 141-2 is formed between a ground source VSS and the first output terminal PAD OUT1.

The resistor 141-3, the P-type diode 141-1 and the N-type diode 141-2 are formed in the pad so as to prevent ESD (electrostatic discharge).

As the number of pixels of a display panel increases, measures for reducing the area occupied by the pads and the charge sharing switches are required to overcome the limitations in terms of area.

### SUMMARY OF THE INVENTION

Accordingly, the present invention has been made in an effort to solve the problems occurring in the related art, and an object of the present invention is to provide a display panel driving circuit having charge sharing switches formed in pads, wherein charge sharing switches are formed in pads to decrease an area required for forming ESD (electrostatic discharge) protection devices and a heat value and reduce power consumption.

In order to achieve the above object, according to one aspect of the present invention, there is provided a display panel driving circuit including: N number of amplifiers configured to supply N number of output voltages to a display panel; N number of output switches configured to transmit output signals from the N number of amplifiers through N number of pads to the display panel; and a plurality of charge sharing switches configured to share charges among the N number of pads, wherein the charge sharing switches are formed in the pads.

### BRIEF DESCRIPTION OF THE DRAWINGS

The above objects, and other features and advantages of the present invention will become more apparent after a reading of the following detailed description taken in conjunction with the drawings, in which:

FIG. 1 is a diagram illustrating a conventional display panel driving circuit;

FIG. 2 is a diagram illustrating circuits on a line through which data is outputted to a first pad by driving one data voltage in the display panel driving circuit shown in FIG. 1 and equivalent circuits in the first pad;

FIG. 3 is a diagram illustrating a display panel driving circuit having charge sharing switches formed in pads in accordance with an embodiment of the present invention;

FIG. 4 is a diagram illustrating another embodiment of the display panel driving circuit having charge sharing switches formed in pads shown in FIG. 3;

FIG. 5 is a longitudinal cross-sectional view illustrating the first charge sharing switch formed in the first pad shown in FIG. 3; and

FIG. 6 is an equivalent circuit diagram of the display panel driving circuit having charge sharing switches formed in pads shown in FIG. 3, which has the pad structure as shown in FIG. 5.

### DETAILED DESCRIPTION OF PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

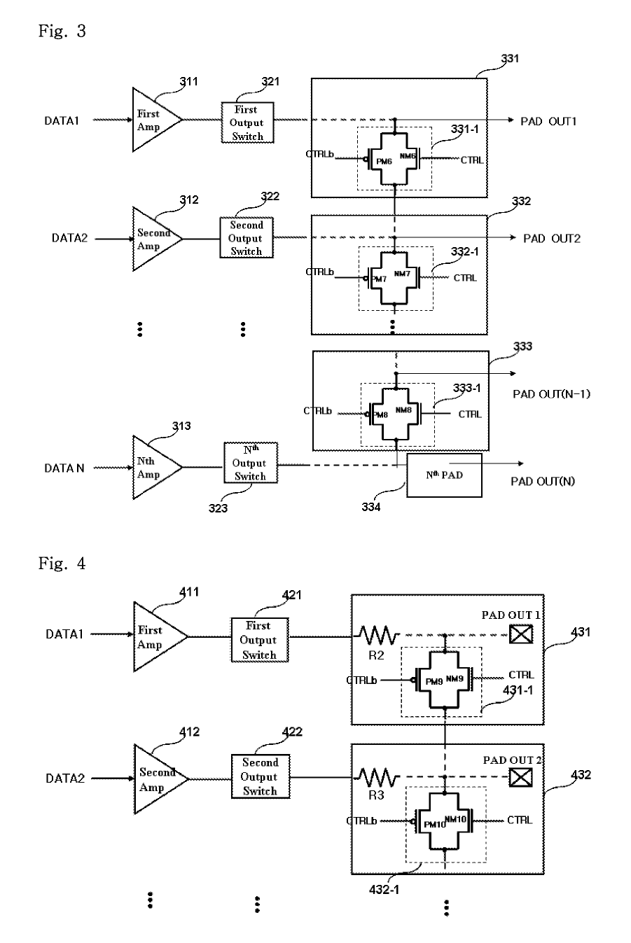

FIG. 3 is a diagram illustrating a display panel driving circuit having charge sharing switches formed in pads in accordance with an embodiment of the present invention.

Referring to FIG. 3, a display panel driving circuit having charge sharing switches formed in pads in accordance with an embodiment of the present invention includes N number of amplifiers 311, 312 and 313, N number of output switches 321, 322 and 323, N number of pads 331, 332, 333 and 334, and charge sharing switches 331-1, 332-1 and 333-1 which are formed in the pads 331, 332 and 333.

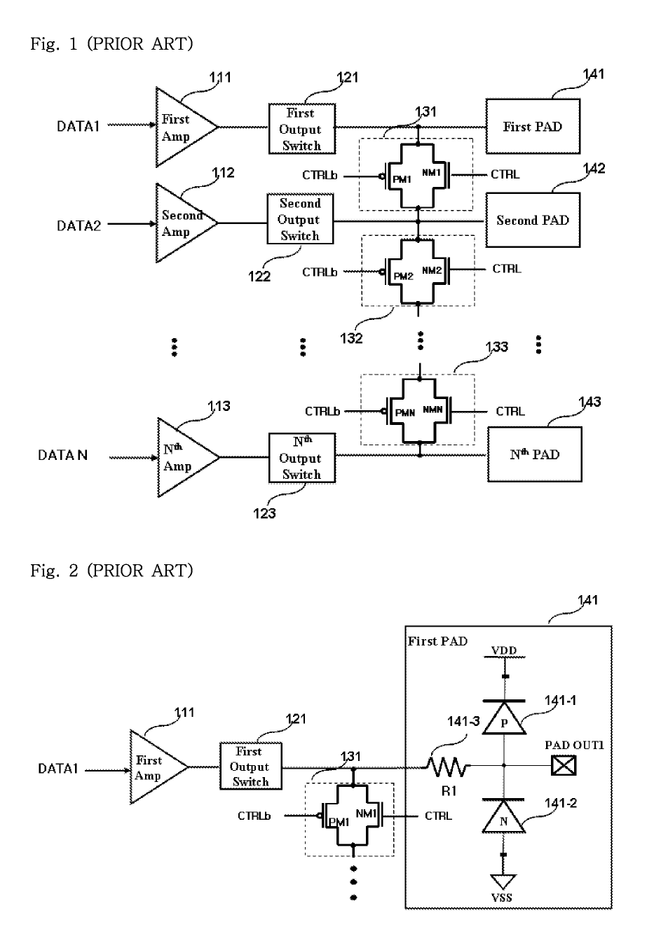

In the display panel driving circuit having charge sharing switches formed in pads, charge sharing switches are formed in pads unlike the conventional art shown in FIG. 1 in which pads and charge sharing switches are separately formed.

The N number of amplifiers 311, 312 and 313 are configured to buffer or amplify corresponding data DATA1, DATA2 and DATA N. The N number of output switches 321, 322 and 323 are configured to respectively receive the outputs of the N number of amplifiers 311, 312 and 313 and allow or interrupt the transmission of the outputs to the pads 331, 332 and 333. The plurality of charge sharing switches 331-1, 332-1 and 333-1 are configured to share charges between the outputs of adjacent pads. Corresponding charge sharing switches are formed in the respective pads. Each charge sharing switch is connected between adjacent pads.

The amplifiers, the output switches and the pads are provided in the number of N. Although the charge sharing switches are provided in the number of N−1, all the outputs of the pads can be shared. Accordingly, respective charge sharing switches are provided to connect adjacent pads among the N number of pads 331, 332, 333 and 334. Among the N number of pads 331, 332, 333 and 334, the first pad 331 or the N^{th} pad 334 which is positioned outermost may not be provided with a charge sharing switch

As shown in FIG. 3, the N^{th} pad 334 is not provided with a charge sharing switch, and the charge sharing switch formed in the N−1^{st} pad 333 shares the outputs of adjacent pads. The N^{th} pad 334 is formed with diodes for ESD protection.

Each of the plurality of charge sharing switches can be realized using two transistors.

For example, the first charge sharing switch 331-1 has a sixth PMOS transistor PM6 and a sixth NMOS transistor NM6.

The sixth NMOS transistor NM6 is formed in the first pad 331, and has a gate which receives a control signal CTRL, a first terminal which is connected to the output of the first pad 331 and a second terminal which is connected to the output of the second pad 332.

The sixth PMOS transistor PM6 is formed in the first pad 331, and has a gate which receives a complementary signal CTRLb of the control signal CTRL, a first terminal which is connected to the output of the first pad 331 and a second terminal which is connected to the output of the second pad 332.

While not shown in a drawing, in a second embodiment of the present invention, the N number of output switches 321, 322 and 323 are respectively formed in the N number of pads 331, 332, 333 and 334.

FIG. 4 is a diagram illustrating another embodiment of the display panel driving circuit having charge sharing switches formed in pads shown in FIG. 3.

The display panel driving circuit shown in FIG. 4 is distinguished from the display panel driving circuit having charge sharing switches formed in pads shown in FIG. 3 in that resistors R2 and R3 for ESD protection are additionally included in the pads.

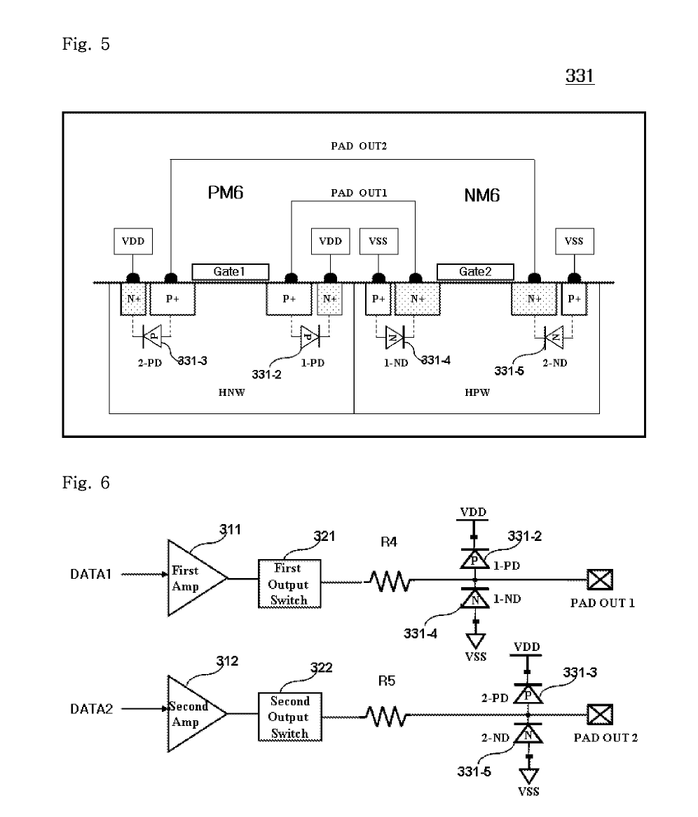

FIG. 5 is a longitudinal cross-sectional view illustrating the first charge sharing switch 331-1 formed in the first pad 331 shown in FIG. 3.

The sixth PMOS transistor PM6 is formed in N-type wells, and the sixth NMOS transistor NM6 is formed in P-type wells.

The first terminal of the sixth PMOS transistor PM6 and the first terminal of the sixth NMOS transistor NM6 are connected with each other. The respective first terminals constitute an output PAD OUT1 of the first pad.

The second terminal of the sixth PMOS transistor PM6 and the second terminal of the sixth NMOS transistor NM6 are connected with each other. The respective second terminals constitute an output PAD OUT2 of the second pad.

The N-type wells are formed on a silicon substrate, and a highly doped P-type source and a highly doped P-type drain are formed on the N-type wells, a first gate oxide is formed on an N-type channel, and a first gate terminal Gate1 is formed on the first gate oxide, by which the sixth PMOS transistor PM6 is formed. Also, highly doped N-type (N+) terminals for a power supply source VDD, that is, N+ well taps or guard rings are formed in the number of 2.

Further, the P-type wells are formed on the silicon substrate, and a highly doped N-type source and a highly doped N-type drain are formed on the P-type wells, a second gate oxide is formed on a P-type channel, and a second gate terminal Gate2 is formed on the second gate oxide, by which the sixth NMOS transistor NM6 is formed. Also, highly doped P-type (P+) terminals for a ground source VSS, that is, P+ well taps or guard rings are formed in the number of 2.

Parasitic P-type diodes 331-2 and 331-3 are formed in the sixth PMOS transistor PM6 by the highly doped N-type terminals for the power supply source VDD and the highly doped P-type terminals as the source terminal and the drain terminal of the sixth PMOS transistor PM6. Also, parasitic N-type diodes 331-4 and 331-5 are formed in the sixth NMOS transistor NM6 by the highly doped P-type terminals for the ground source VSS and the highly doped N-type terminals as the source terminal and the drain terminal of the sixth NMOS transistor NM6.

That is to say, it is to be understood that the P-type diodes 331-2 and 331-3 and N-type diodes 331-4 and 331-5 as parasitic diodes are formed in the sixth PMOS transistor PM6 and sixth NMOS transistor NM6 which realize the first charge sharing switch 331.

Since the parasitic diodes can perform the function of diodes according to the conventional art, it is not necessary to separately form diodes, whereby an area reduction effect can be accomplished.

FIG. 6 is an equivalent circuit diagram of the display panel driving circuit having charge sharing switches formed in pads shown in FIG. 3, which has the pad structure as shown in FIG. 5.

Referring to FIG. 6, it is to be appreciated that N-type diodes 331-4 and 331-5 and P-type diodes 331-2 and 331-3 for ESD protection are formed in charge sharing switches.

In the present invention, the following effects are achieved due to the fact that the charge sharing switches are formed in the pads.

First, while charge sharing switches and pads are separately formed in the conventional art, the charge sharing switches are formed in the pads in the present invention, whereby an area is significantly decreased.

Second, while diodes for ESD protection are formed in the pads in the conventional art, problems related with electrostatic discharge are solved in the present invention by parasitic diodes naturally formed in the charge sharing switches inside the pads, whereby an area required for additionally forming diodes can be saved.

Third, as lines from the charge sharing switches to the pads are shortened, line resistance is reduced, whereby a heating value and power consumption can be decreased.

As is apparent from the above description, the display panel driving circuit having charge sharing switches formed in pads according to the present invention provides advantages in that charge sharing switches are formed in pads and problems related with electrostatic discharge are solved by parasitic diodes naturally formed in the charge sharing switches inside the pads, thereby significantly decreasing an area.

Also, in the present invention, since line resistance from the charge sharing switches to the pads can be reduced, a heat value and power consumption can be reduced.

Although a preferred embodiment of the present invention has been described for illustrative purposes, those skilled in the art will appreciate that various modifications, additions and substitutions are possible, without departing from the scope and the spirit of the invention as disclosed in the accompanying claims.

What is claimed is:

1. A display panel driving circuit comprising:
N number of amplifiers configured to supply N number of output voltages to a display panel;
N number of output switches configured to transmit output signals from the N number of amplifiers through N number of pads to the display panel; and
a plurality of charge sharing switches configured to share charges among the N number of pads,
wherein the charge sharing switches are formed in the pads.

2. The display panel driving circuit according to claim 1, wherein the output switches are formed in the pads.

3. The display panel driving circuit according to claim 2, wherein the output switches or the charge sharing switches are designed based on an I/O design rule.

4. The display panel driving circuit according to claim 1, wherein each of the charge sharing switches comprises a plurality of transistors which are configured to share or separate charges between adjacent pads in response to a control signal, and
wherein an ESD protection device is constituted by parasitic diodes which are formed by P+ type source and drain and N+ type well taps or guard rings in a PMOS transistor of the plurality of transistors and parasitic diodes which are formed by N+ type source and drain and P+ type well taps or guard rings in an NMOS transistor of the plurality of transistors.

5. The display panel driving circuit according to claim 1,
wherein the N number of pads comprise first to N^{th} pads,
wherein the plurality of charge sharing switches comprise first through N−1^{th} charge sharing switches, and
wherein the first charge sharing switch comprises:
a first NMOS transistor having a gate which receives the control signal, a first terminal which is connected to an output of the first pad, and a second terminal which is connected to an output of the second pad; and
a first PMOS transistor having a gate which receives a complementary signal of the control signal, a first terminal which is connected to the output of the first pad, and a second terminal which is connected to the output of the second pad.

6. The display panel driving circuit according to claim 1, wherein separate diodes for ESD protection are not provided in the pads.

7. The display panel driving circuit according to claim 1, wherein separate resistors for ESD protection are not provided in the pads.

8. The display panel driving circuit according to claim 1, wherein separate resistors for ESD protection are provided in the pads.

9. The display panel driving circuit according to claim 2,
wherein each of the charge sharing switches comprises a plurality of transistors which are configured to share or separate charges between adjacent pads in response to a control signal, and
wherein an ESD protection device is constituted by parasitic diodes which are formed by P+ type source and drain and N+ type well taps or guard rings in a PMOS transistor of the plurality of transistors and parasitic diodes which are formed by N+ type source and drain and P+ type well taps or guard rings in an NMOS transistor of the plurality of transistors.

10. The display panel driving circuit according to claim 2,
wherein the N number of pads comprise first to N^{th} pads,
wherein the plurality of charge sharing switches comprise first through N−1^{th} charge sharing switches, and
wherein the first charge sharing switch comprises:
a first NMOS transistor having a gate which receives the control signal, a first terminal which is connected to an output of the first pad, and a second terminal which is connected to an output of the second pad; and
a first PMOS transistor having a gate which receives a complementary signal of the control signal, a first terminal which is connected to the output of the first pad, and a second terminal which is connected to the output of the second pad.

11. The display panel driving circuit according to claim 2, wherein separate diodes for ESD protection are not provided in the pads.

12. The display panel driving circuit according to claim 2, wherein separate resistors for ESD protection are not provided in the pads.

13. The display panel driving circuit according to claim 2, wherein separate resistors for ESD protection are provided in the pads.
